(19) United States
(12) Patent Application Publication
(10) Pub. No.: US 2026/0364591 A1
(43) Pub. Date: Nov. 19, 2026

(54) PIPETTE CONTROLLER

(71) Applicant: Vistalab Technologies, LLC, Patterson, NY (US)

(72) Inventor: Jeffrey Emerson Calhoun, Pleasantville, NY (US)

(21) Appl. No.: 19/675,293

(22) Filed: May 12, 2026

Related U.S. Application Data
(60) Provisional application No. 63/805,188, filed on May 13, 2025.

(51) Int. Cl. B01L 3/02

(52) U.S. Cl. CPC B01L 3/0237; B01L 2300/0627; B01L 2400/0487; B01L 2400/0694; B01L 2400/082

(57) ABSTRACT

A pipette controller includes a pipette holder configured to operatively connect a pipette to the pipette controller, a pressure tank pneumatically connected to the pipette holder, a pump pneumatically connected to the pipette holder and to the pressure tank, a dispense valve, an aspiration valve, and an electronic controller in electrical communication with the pump, the dispense valve, and the aspiration valve. The electronic controller is configured, in response to receiving an aspiration command signal from the aspiration valve, to operate the pump to draw in air from the pipette holder and into the pressure tank, and, in response to receiving a dispense command signal from the dispense valve, to release accumulated air from within the pressure tank to flow into the pipette holder.

### CROSS REFERENCE TO RELATED APPLICATIONS

This application claims the benefit of priority of U.S. Provisional Patent Application No. 63/805,188, filed on May 13, 2025, the contents of which is hereby incorporated by reference in its entirety.

### TECHNICAL FIELD

The present disclosure relates generally to pipette controllers.

### BACKGROUND

Pipette controllers generally provide for aspirating liquid into a pipette and dispensing of aliquots of liquid from the pipette. Pipette controllers are commonly utilized in laboratory settings for liquid measurement and dispensing to perform various scientific tasks, such as drug development, environmental testing, and diagnostic testing.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, or structurally similar elements.

FIG. 1 is an elevational view of an exemplary pipette controller, according to the present disclosure.

FIG. 2 is a schematic diagram of components of the pipette controller of FIG. 1.

FIGS. 3A and 3B are flowcharts depicting an exemplary aliquot mode of the pipette controller of FIG. 1.

FIG. 4 is a schematic diagram of serological pipette pressures.

FIG. 5 is a schematic diagram of a serological pipette disposed vertically and disposed at an angle.

FIG. 6 is a flowchart showing an exemplary method of aspirating and dispensing a fluid from a pipette using a pipette controller, such as the pipette controller of FIG. 1, according to the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below.

While specific embodiments are discussed, this is done for illustration purposes only. A person skilled in the relevant art will recognize that other components and configurations may be used without departing from the present disclosure.

Although the term “pipette” and “pipette controller” may be used to describe embodiments of the present disclosure, a person skilled in the relevant art will recognize that other devices that aspirate and dispense fluids may be used without departing from the spirit and scope of the present disclosure.

As used herein, the terms “first,” “second,” “third,” etc., may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, two, four, ten, fifteen, or twenty percent margin in either individual values, range(s) of values and/or endpoints defining range(s) of values.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

The present disclosure provides for a pipette controller for aspirating precise aliquots of fluid into a pipette and precisely dispensing multiple aliquots of the liquid from the pipette. The fluid in the pipette may alternatively be manually dispensed by the pipette controller. An aspirate volume or a dispense volume to be dispensed by the pipette controller can be varied by a user.

Serological pipettes are widely used for liquid measurement and dispensing in laboratories. Depending on a particular application, such pipettes may be formed of various materials, e.g., glass or plastic, and may be provided in various sizes, e.g., one (1) milliliter (ml) to one hundred (100) ml, with graduations printed on them. Traditionally, liquid was drawn into such pipettes by applying suction to the top end thereof by a rubber bulb, measured by aspirating to a graduation line, and then dispensed by removing the suction. Current practice often utilizes a pipette controller, which uses a small, battery-powered air pump and trigger-style pneumatic valves to manipulate pressure inside of serological pipettes to draw up and then to expel liquid therefrom.

Frequently, multiple aliquots of a liquid sample must be dispensed for analytical processes. To do this, a user first aspirates slightly more than the required volume and then slowly dispenses the sample until the meniscus of the fluid aligns with a graduation line on the serological pipette to achieve a starting volume. The user must note the starting volume and then dispense fluid until the meniscus drops to the graduation line corresponding to the difference between the starting volume and the desired dispense volume. If another aliquot is required, the user dispenses again to the graduation line corresponding to the difference between the prior reading and the desired volume. However, this methodology is a time consuming and fatiguing process, especially when this process must be repeated many times. In addition, this process introduces multiple sources of error.

Accordingly, the present disclosure provides for a pipette controller that can provide for accurate dispensing of aliquots of liquid via a single dispense actuator. Thus, embodiments of the present disclosure can provide a pipette controller that accurately dispenses aliquots of liquid, but with a significantly less complex system structure, thus, providing a reduced overall size and weight, as compared to conventional pipette controllers.

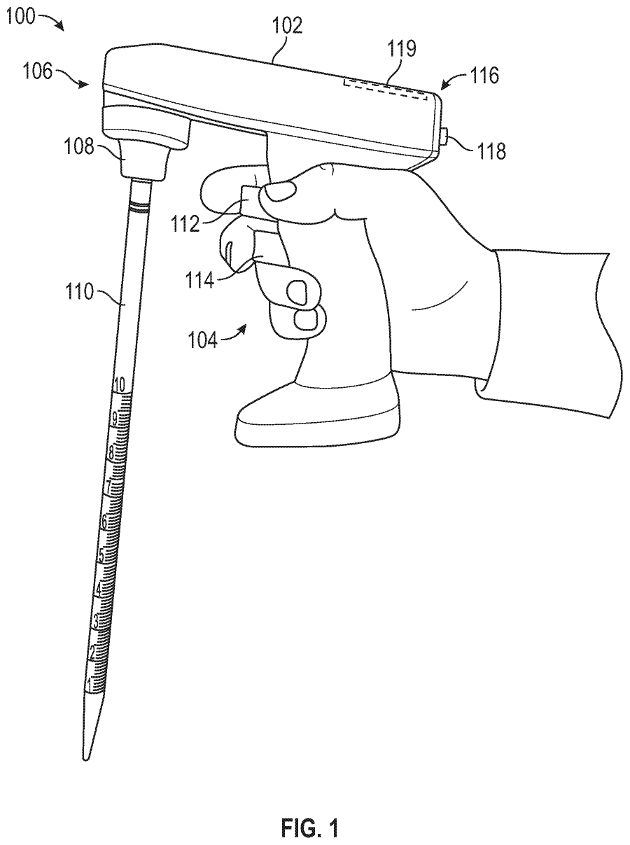

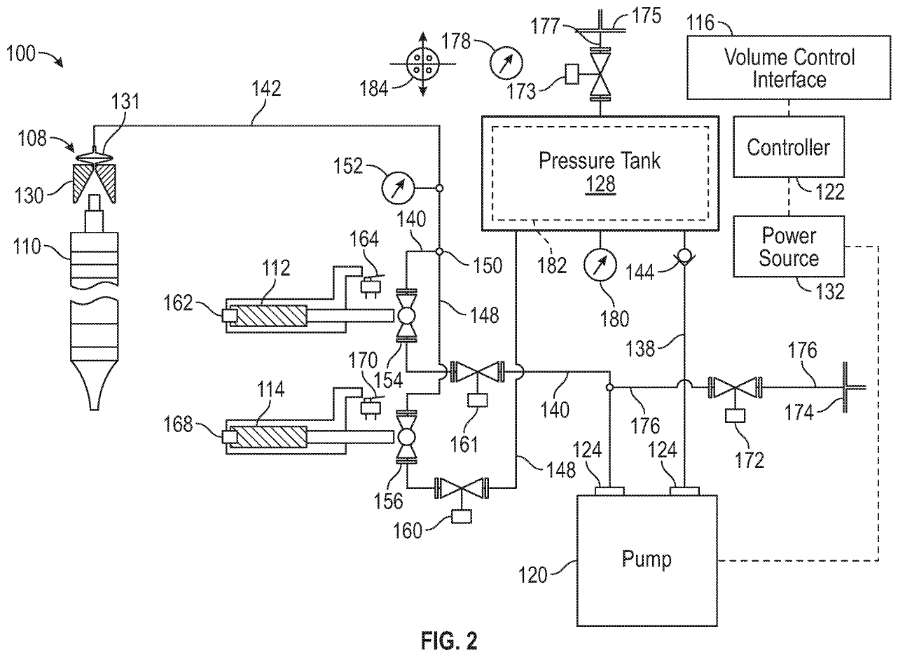

Referring now to the drawings, FIG. 1 illustrates an exemplary pipette controller 100, according to an embodiment of the present disclosure. The pipette controller 100 includes a housing 102 with a lower housing portion 104 and an upper housing portion 106 extending from the lower housing portion 104. As shown in FIG. 1, the lower housing portion 104 is configured to be grasped in a palm of a hand of a user in order to operate the pipette controller 100. A nozzle assembly 108 extends from a distal end of the upper housing portion 106 and is configured to removably receive a serological pipette 110. As will be discussed in greater detail below with reference to FIG. 2, when the pipette 110 is received by the nozzle assembly 108, the pipette 110 is pneumatically connected to the pipette controller 100 via a cone seal 130 (FIG. 2) of the nozzle assembly 108. The pipette 110 may be removed from nozzle assembly 108 by engaging a portion of the nozzle assembly 108, such as a cover that engages the cone seal 130 (FIG. 2). As such, a user of the pipette controller 100 may quickly remove and replace the pipette 110, via the nozzle assembly 108, with another, sterile pipette having one or more different characteristics, e.g., a different size.

An aspiration actuator 112 and a dispense actuator 114 extend from the lower housing portion 104 and are configured to be engageable by one or more fingers of the user during operation of the pipette controller 100. As will be discussed in greater detail below with reference to FIG. 2, the pipette controller 100 may aspirate a volume of a fluid into the pipette 110 when the user depresses aspiration actuator 112 and may dispense fluid from the pipette 110 when the user depresses dispense actuator 114. Although the aspiration actuator 112 and the dispense actuator 114 are depicted as buttons in the illustrated embodiment of FIG. 1, the aspiration actuator 112 and the dispense actuator 114 may be any type of user interface that can be engageable by a user.

Referring still to FIG. 1, the pipette controller 100 further includes an volume control interface 116 disposed toward a proximal end of the upper housing portion 106 of the housing 102. As will be discussed in greater detail below with reference to FIG. 2, the volume control interface 116 is operable by the user to select a set aliquot volume that is dispensed from the pipette when the pipette controller is operating in an aliquot mode (as opposed to a dispense mode) or to select a set aspiration volume that is aspirated into the pipette when the pipette controller is operating in a measured aspiration mode or a dilution mode (as opposed to a manual aspiration mode). In some embodiments, the volume control interface 116 may be operable by the user to switch between the aliquot mode, the dispense mode, the measured aspiration mode, the manual aspiration mode, and the dilution mode. In the illustrated embodiment, the volume control interface 116 includes one or more control buttons 118 operable by a user to adjust a set aliquot volume or a set aspiration volume of the pipette controller 100 and a display screen 119 (e.g., a liquid-crystal display (LCD), an electronic paper (E-ink) display, among others) to display one or more operational parameters of the pipette controller 100. For example, in some embodiments, the display screen 119 may display the set aliquot volume, the set aspiration volume, a currently selected operating mode (e.g., a dispense mode, an aliquot mode, a manual aspiration mode, a measured aspiration mode, or a dilution mode), a battery percentage of a power source (e.g., power source 132 of FIG. 2), among others.

In some embodiments, the one or more control buttons 118 of the volume control interface 116 may be touch capacitive sensors configured to receive a user input via contact with a user's finger. In some embodiments, the volume control interface 116 can include a dial or a keypad. In some embodiments, the pipette controller 100 may be configured to connect to a user's mobile device (e.g., a mobile phone, a smartwatch, etc.) and the volume control interface 116 can be provided on the user's mobile device. In some embodiments, the pipette controller 100 may further include one or more visual, audio, or haptic indicators that are configured to indicate one or more operational parameters to the user. For example, in some embodiments, a vibrational indicator may be disposed within the lower housing portion 104 of the housing 102 that may cause vibrations to the user's hand to indicate to the user that the pipette controller 100 is ready for a subsequent aliquot dispense.

Referring now to FIG. 2, the pipette controller 100 further includes a pump 120 and an electronic controller 122 that is powered by a power source 132. The electronic controller 122 is in electrical communication with the volume control interface 116 and the pump 120 such that the volume control interface 116 and the pump 120 are powered by the power source 132. In some embodiments, the power source 132 can be a battery that is rechargeable or replaceable within the housing 102. In some embodiments, the power source 132 can be a power input that is configured to connect to a power source external to the pipette controller 100.

The pump 120 has a pump outlet 124 that is pneumatically connected to a pressure tank 128 via a pump conduit 138 and a pump inlet 126 that is pneumatically connected to the nozzle assembly 108 via an aspiration conduit 140 extending from the pump inlet 126 to a pipette conduit 142, which extends from the nozzle assembly 108. As will be discussed in greater detail below, the pump 120 is configured to draw in air from the nozzle assembly 108 (i.e., and from the pipette 110 coupled to the cone seal 130 thereto) along the aspiration conduit 140 to aspirate a volume of fluid into the pipette 110 (e.g., with the pipette controller 100 operating in a measured aspiration mode, a manual aspiration mode, or a dilution mode) and to inject air along the pump conduit 138 into the pressure tank 128 to create positive air pressure inside the pressure tank 128 that is used to dispense an aliquot volume from the pipette 110 (e.g., with the pipette controller 100 operating in a dispense mode or an aliquot mode). A check valve 144 may be disposed along the pump conduit 138 to prevent pressurized air from leaking out of the pressure tank 128 to the pump conduit 138 when the pump 120 is not operated.

With continued reference to FIG. 2, the pressure tank 128 is also pneumatically connected to the nozzle assembly 108 (via the pipette conduit 142) by a dispense conduit 148 extending from the pressure tank 128 to the pipette conduit 142. Thus, in the illustrated embodiment, the pipette conduit 142 is pneumatically connected to both the aspiration conduit 140 and the dispense conduit 148 at a junction 150. Particularly, the pipette conduit 142 is pneumatically connected to the junction 150 at one end and to the cone seal 130 of the nozzle assembly 108 at the other end. As shown in FIG. 2, the nozzle assembly 108 can further include an air filter 131 arranged between the pipette conduit 142 and the cone seal 130 that can reduce or prevent debris from entering the pipette conduit 142 or from entering the pipette 110. In some embodiments, a manifold may be arranged at junction 150 that may be configured to direct flow between the pipette conduit 142, the aspiration conduit 140, and the dispense conduit 148.

As shown in the illustrated embodiment, a pipette pressure sensor 152 is arranged at the junction 150 to sense an air pressure within the pipette conduit 142 (and thus also within the pipette 110 attached to the nozzle assembly 108). The pipette pressure sensor 152 is in electrical communication with the electronic controller 122, which is configured to receive signals from the pipette pressure sensor 152. In some embodiments, the pipette pressure sensor 152 can be arranged along the pipette conduit 142 between the nozzle assembly 108 and the junction 150. In some embodiments, the pipette pressure sensor 152 can be part of the nozzle assembly 108.

Referring still to FIG. 2, an aspiration valve 154 is arranged along the aspiration conduit 140 between the pump inlet 126 and the junction 150. The aspiration valve 154 is operably coupled to the aspiration actuator 112. In this way, the aspiration actuator 112 is operable by the user to move the aspiration valve 154 from a closed position, in which the aspiration valve 154 prevents airflow along the aspiration conduit 140, toward an open position, in which the aspiration valve 154 permits airflow along the aspiration conduit 140.

Similarly, a dispense valve 156 is arranged along the dispense conduit between the pressure tank 128 and the junction 150. The dispense valve 156 is operably coupled to the dispense actuator 114. In this way, the dispense actuator 114 is operable by the user to move the dispense valve 156 from a closed position, in which the dispense actuator 114 prevents airflow along the dispense conduit 148, toward an open position, in which the dispense actuator 114 permits airflow along the dispense conduit 148. In the illustrated embodiment, the aspiration valve 154 and the dispense valve 156 are normally closed ball valves.

An aspiration switch 164 and a dispense switch 170 are in electrical communication with the electronic controller 122 and are arranged to detect movement of the aspiration actuator 112 and the dispense actuator 114, respectively. Particularly, while the pipette controller 100 is operated in the manual aspiration mode, the measured aspiration mode, or the dilution mode, the aspiration switch 164 provides an aspiration command signal to the electronic controller 122 when the aspiration actuator 112 is actuated (e.g., moved by the user to move the aspiration valve 154 from the closed position). Likewise, while the pipette controller 100 is operated in the dispense mode, the dispense switch 170 provides a dispense command signal to the electronic controller 122 when the dispense actuator 114 is actuated (e.g., e.g., moved by the user to move the dispense valve 156 from the closed position). Further, while the pipette controller 100 is operated in the aliquot mode, the dispense switch 170 can also provide an aliquot command signal to the electronic controller 122 when the dispense actuator 114 is actuated.

In some embodiments, the aspiration actuator 112 can further include an aspiration interface 162 that is movable from a disengaged position, in which the aspiration valve 154 is in the closed position, and an engaged position, in which the aspiration valve 154 is in the fully open position. In some such embodiments, the aspiration interface 162 can biased toward the disengaged position, and the aspiration switch 164 can be arranged to detect movement of the aspiration interface 162 from the disengaged position (i.e., an aspiration trigger event) and to provide the aspiration command signal to the electronic controller 122. In some embodiments, the dispense actuator 114 can further include a dispense interface 168 that is movable from a disengaged position, in which the dispense valve 156 is in the closed position, and an engaged position, in which the dispense valve 156 is in the fully open position. In some such embodiments, the dispense interface 168 can biased toward the disengaged position, and the dispense switch 170 can be arranged to detect movement of the dispense interface 168 from the disengaged position (e.g., a dispense trigger event) and to provide the dispense command signal or the aliquot command signal to the electronic controller 122. In some embodiments, one or both of the aspiration interface 162 or the dispense interface 168 can be a button that is depressible by the user.

With continued reference to FIG. 2, an aliquot valve 160 is arranged along the dispense conduit 148 between the pressure tank 128 and the dispense valve 156. In other words, the aliquot valve 160 is located upstream from the dispense valve 156 relative to airflow along the dispense conduit 148 as pressurized air provided from the pressure tank 128 flows to the pipette conduit 142. In the illustrated embodiment, the aliquot valve 160 is a normally open solenoid actuated ball valve that is in electrical communication with the electronic controller 122. In this way, the electronic controller 122 is configured to move the aliquot valve 160 from an open position, in which the aliquot valve 160 permits airflow along the dispense conduit 148, to a closed position, in which the aliquot valve prevents airflow along the dispense conduit 148. In other embodiments, the aliquot valve 160 can be any other type of two-way valve.

An aspiration control valve 161 is arranged along the aspiration conduit 140 between the pump inlet 126 and the aspiration valve 154. In other words, the aspiration control valve 161 is located downstream from the aspiration valve 154 relative to airflow along the aspiration conduit 140 as air is drawn from the nozzle assembly 108 along the aspiration conduit 140. In the illustrated embodiment, the aspiration control valve 161 is a normally open solenoid actuated ball valve that is electrically connected to the electronic controller 122, and the electronic controller 122 is configured to move the aspiration control valve 161 from an open position, in which the aspiration control valve 161 permits airflow along the aspiration conduit 140, to a closed position, in which the aspiration control valve 161 prevents airflow along the aspiration conduit 140. In other embodiments, the aspiration control valve 161 can be any other type of two-way valve. In some embodiments, the aspiration control valve 161 may be located upstream from the aspiration valve 154 relative to airflow along the aspiration conduit 140 as air is drawn from the nozzle assembly 108 along the aspiration conduit 140.

Referring still to FIG. 2, a dispense vent valve 172 is pneumatically connected to the aspiration conduit 140 and to a dispense air vent 174 via a dispense vent conduit 176. The dispense air vent 174 is in fluid communication with atmospheric air external to the pipette controller 100. In the illustrated embodiment, the dispense vent valve 172 is a normally closed, two-way solenoid actuated ball valve in electrical communication with the electronic controller 122. In this way, the electronic controller 122 is configured to selectively move the dispense vent valve 172 between a first position, in which airflow is prevented between the aspiration conduit 140 and the dispense air vent 174, and a second position, in which airflow is permitted between the aspiration conduit 140 and the dispense air vent 174. An atmospheric pressure sensor 178 is in electrical communication with the electronic controller 122 and arranged within the housing 102 (FIG. 1) to sense an atmospheric pressure external to the pipette controller 100. In some embodiments, the dispense vent valve 172 can be a normally open valve (e.g., a normally open, two-way solenoid actuated ball valve).

A tank vent valve 173 is pneumatically connected to the pressure tank 128 and to a pressure tank vent 175 via an aspiration vent conduit 177. Similar to the dispense air vent 174, the pressure tank vent 175 is in fluid communication with atmospheric air external to the pipette controller 100. In the illustrated embodiment, the tank vent valve 173 is a normally closed, two-way solenoid actuated ball valve electrically connected to the electronic controller 122. As such, the electronic controller 122 is configured to selectively move the tank vent valve 173 between a first position, in which airflow is prevented to flow from the pressure tank 128 through the tank vent valve 173, and a second position, in which air is permitted to flow from the pressure tank 128 to atmosphere via the tank vent valve 173. In some embodiments, the tank vent valve 173 can be a normally open valve (e.g., a normally open, two-way solenoid actuated ball valve).

In some embodiments, the pump conduit 138, the aspiration conduit 140, the pipette conduit 142, the dispense conduit 148, the dispense vent conduit 176, and the aspiration vent conduit 177 may be tubing (e.g., plastic tubing) that pneumatically connects the respective components of the pipette controller 100. Thus, as compared to pipette controllers without the benefit of the present disclosure, an overall length of tubing of the pipette controller 100 may be reduced due to the particular configuration of the pipette controller 100. For example, as compared to conventional pipette controllers, the pipette controller 100 does not include a vacuum tank pneumatically connected to the nozzle assembly 108.

As mentioned above, the pipette controller 100 is configured to operate in the manual aspiration mode, in which the user manually aspirates fluid into the pipette 110 via the aspiration actuator 112, and the dispense mode, in which the user manually dispenses fluid from the pipette 110 via the dispense actuator 114. The manual aspiration mode is initiated by actuation of the aspiration actuator 112 (or engagement of the aspiration interface 162) by the user, which causes the aspiration switch 164 to provide the aspiration command signal to the electronic controller 122. In response to receiving the aspiration command signal from the aspiration switch 164, the electronic controller 122 moves the tank vent valve 173 from the first position to the second position, which permits airflow between the pressure tank 128 and the pressure tank vent 175. In the illustrated embodiment, the dispense vent valve 172 is normally closed (i.e., in the first position) and the aspiration control valve 161 is normally open (i.e., in the first position), and thus the electronic controller 122 does not move the dispense vent valve 172 and the aspiration control valve 161 from the respective first positions when the aspiration command signal is received from the aspiration switch 164.

With the tank vent valve 173 in the second position, the electronic controller 122 then operates the pump 120 to draw in air from the nozzle assembly 108 along the pipette conduit 142 to the aspiration conduit 140, through the aspiration valve 154 and the aspiration control valve 161 to the pump inlet 126, and to the pressure tank 128 via the pump outlet 124 and the pump conduit 138. Air that accumulates within the pressure tank 128 during continued operation of the pump 120 is vented to atmosphere along the aspiration vent conduit 177 through the tank vent valve 173 to the pressure tank vent 175. Once the user disengages the aspiration actuator 112, which closes the aspiration valve 154 and disengages the aspiration switch 164, the electronic controller 122 ceases operation of the pump 120 and airflow along the aspiration conduit 140 is not permitted by the disengaged aspiration valve 154.

From the manual aspiration mode, the dispense mode is initiated by actuation of the dispense actuator 114 (or engagement of the dispense interface 168) by the user, which causes the dispense switch 170 to provide the dispense command signal to the electronic controller 122. In response to receiving the dispense command signal from the dispense switch 170, the electronic controller 122 moves the dispense vent valve 172 from the first position to the second position, which permits airflow from the dispense air vent 174 to the pump inlet 126 via the aspiration conduit 140. In the illustrated embodiment, the tank vent valve 173 is normally closed (i.e., in the first position) and the aliquot valve 160 is normally open (i.e., in the first position), and thus the electronic controller 122 does not move the tank vent valve 173 and the aliquot valve 160 from the respective first positions when dispense command signal from the dispense switch 170 is received.

With the dispense vent valve 172 in the second position, the electronic controller 122 then operates the pump 120 to inject air (e.g., atmospheric air from the dispense air vent 174) into the pressure tank 128 along the dispense vent conduit 176 to pump inlet 126 (via the aspiration conduit 140) and from pump outlet 124 to the pump conduit 138. Positive air pressure from the pressure tank 128 then flows along the dispense conduit 148, through the aliquot valve 160 and the dispense valve 156, to the nozzle assembly 108 and thus dispensing an aliquot volume of fluid contained within the pipette 110. More specifically, in the illustrated embodiment, positive air pressure from the pressure tank 128 flows along the dispense conduit 148 through the aliquot valve 160 and then through the dispense valve 156 to the nozzle assembly 108. In other words, a volume of a dispense of fluid released from the pipette 110 as the pipette controller 100 is operating in the dispense mode is controllable by the user via the dispense actuator 114.

In some embodiments, while operating in the dispense mode, a dispense speed of a dispense by the pipette controller 100 can be varied by the user. For example, in some such embodiments, the dispense actuator 114 can be configured such that the dispense valve 156 is movable, via the dispense actuator 114, to one of a plurality of partially open positions between the closed position and the fully open position to vary flow of the positive air pressure through the dispense valve 156. In other embodiments, a dispense speed of a dispense by the pipette controller 100 can be selectable by the user (e.g., via the volume control interface 116).

While operating in the dispense mode, the tank pressure within the pressure tank 128 will decrease from the predetermined target tank pressure after one or more dispenses are released from the pipette 110. Accordingly, in some embodiments, the electronic controller 122 can be configured to reinject air into the pressure tank 128, via the pump 120, to the predetermined target tank pressure after each aliquot volume dispensed.

In addition to the dispense mode described above, the pipette controller 100 can also be operated, via the electronic controller 122, in the aliquot mode. In the aliquot mode, a precise aliquot of fluid is dispensed from the pipette 110 in response to an initial engagement of the dispense actuator 114 and again with each subsequent engagement of the dispense actuator 114. For example, twenty (20) ml of fluid may first be aspirated into the pipette 110 by operation of the pipette controller 100 in the aspiration mode. An aliquot volume is selectable by the user (i.e., a set aliquot volume) via the volume control interface 116. Then, upon each engagement of the dispense actuator 114, the set aliquot volume is dispensed. In this example, if the set aliquot volume is two (2) ml, ten distinct aliquots of fluid can be dispensed from the single aspiration of the pipette 110.

To initiate the aliquot mode of the pipette controller 100, a user may select the aliquot mode from the manual aspiration mode or the dispense mode (e.g., via the volume control interface 116). In some embodiments, the user may also select the aliquot volume (i.e., the set aliquot volume) via the volume control interface 116. Prior to the aliquot mode, the pipette 110 may be aspirated (e.g., via the manual aspiration mode, the measured aspiration mode, or the dilution mode) with a volume greater than the set aliquot volume by engaging aspiration actuator 112 until the desired starting volume is aspirated into the pipette 110.

With the pipette controller 100 in the aliquot mode, to dispense a first aliquot, the dispense actuator 114 is engaged and an aliquot of fluid with a volume corresponding to the set aliquot volume is dispensed. Particularly, in response to receiving the aliquot command signal from the dispense switch 170, the electronic controller 122 leaves the dispense valve 172 in the first position, which permits airflow from the dispense air vent 174 to the pump conduit 138, and operates the pump 120 to inject air (e.g., atmospheric air from the air vent 174) along the pump conduit 138 to pressurize the pressure tank 128 to a predetermined target tank pressure. Once the predetermined target tank pressure is achieved within the pressure tank 128 (e.g., as sensed by a pressure tank sensor 180 in electrical communication with the electronic controller 122), the electronic controller 122 releases the aliquot valve 160 from the closed position to the normally open position, which permits positive air pressure from the pressure tank 128 to the nozzle assembly 108 and thus dispensing an aliquot volume of fluid contained within the pipette 110. More specifically, in the illustrated embodiment, positive air pressure from the pressure tank 128 flows through the aliquot valve 160 and then through the dispense valve 156 to the nozzle assembly 108. One or more subsequent aliquots may be dispensed by engaging the dispense actuator 114 until all of the starting volume of the fluid is dispensed from the pipette 110. In other words, with the pipette controller 100 operating in the aliquot mode, the predetermined target tank pressure of the pressure tank 128 is used to dispense one or more aliquots such that the pump 120 is not operated.

In order to provide for increased accuracy of the dispensed aliquot, the aliquot valve 160 is opened before the dispense valve 156 is moved from the closed position toward the open position. Thus, in some embodiments, the dispense switch 170 can be configured to provide the dispense command signal to the electronic controller 122 once the dispense actuator 114 is initially actuated but before the dispense valve 156 is moved from the closed position toward the open position.

In some embodiments, while operating in the aliquot mode, a dispense speed of an aliquot volume by the pipette controller 100 can be varied by the user. For example, in some such embodiments, the dispense actuator 114 can be configured such that the dispense valve 156 is movable, via the dispense actuator 114, to one of a plurality of partially open positions between the closed position and the fully open position to vary flow of the positive air pressure through the dispense valve 156. In other embodiments, a dispense speed of the aliquot volume by the pipette controller 100 can be selectable via the volume control interface 116.

While operating in the aliquot mode, the electronic controller 122 can be configured to determine (e.g., based on signals received from a pressure tank sensor 180) when the tank air pressure reaches a predetermined tank air pressure corresponding to an amount of air transferred from the pressure tank 128 to the nozzle assembly 108 to dispense a volume of fluid equal to the set aliquot volume. The electronic controller 122 can be further configured, when the tank air pressure reaches the predetermined tank air pressure and the dispense actuator 114 is disengaged, to move the aliquot valve 160 from first position to the second position (which prevent airflow along the dispense conduit 148), and then to operate the pump 120 to reinject air into the pressure tank 128 to a predetermined target tank air pressure corresponding to the aliquot volume.

In some embodiments, the electronic controller 122 can be further configured to determine a predetermined target tank air pressure that can provide for two or more set aliquot volumes to be dispensed before air is reinjected into the pressure tank 128 via the pump 120. In some embodiments, the electronic controller 122 can be configured to cycle the dispense vent valve 172 between the first and second positions while the pump 120 is operated in order to maintain the predetermined target tank air pressure within the pressure tank 128.

In some embodiments, the electronic controller 122 may adjust the predetermined tank air pressure based on the size of the set aliquot valve selected by the user. In this way, a reinjection time of the pump 120 to repressurize the pressure tank 128 to the predetermined tank air pressure can be minimized. For example, in some embodiments, the electronic controller 122 can be configured to use a first predetermined tank air pressure for a first set aliquot volume and a second predetermined tank air pressure, that differs from the first predetermined tank air pressure, for a second set aliquot volume, that differs from the first set aliquot volume.

Due to pressure drops within the pressure tank 128 after repeated aliquot dispensing, a temperature within the pressure tank 128 may decrease during an aliquot dispense. As such, in some embodiments, the pressure tank 128 can include a tank air temperature regulator 182 that can be configured to reduce a change in a temperature of the pressurized air within the pressure tank 128 during continued operation of the pipette controller 100 in the aliquot mode. For example, in some embodiments, the tank air temperature regulator 182 can be a fabric material (e.g., polyester) arranged within an internal cavity of the pressure tank 128. In some such embodiments, the fabric material can be arranged throughout an entirety of the internal cavity of the pressure tank 128. In some embodiments, the fabric material can be arranged in layers within the internal cavity of the pressure tank 128.

As discussed in more detail below, the pipette controller 100 can further include an orientation sensor 184 (e.g., a gyroscope) in electrical communication with the electronic controller 122. The orientation sensor 184 can be configured to sense an angle of the pipette 110 relative to a reference axis (e.g., an absolute vertical or horizontal axis). In some embodiments, the electronic controller 122 can be further configured to determine (e.g., based on signals received from the orientation sensor 184) an angle of the pipette 110 relative to the reference axis, and to adjust, based on the determined angle of the pipette 110, the amount of air transferred from the pressure tank 128 to the nozzle assembly 108 to dispense the volume of fluid equal to the set aliquot volume.

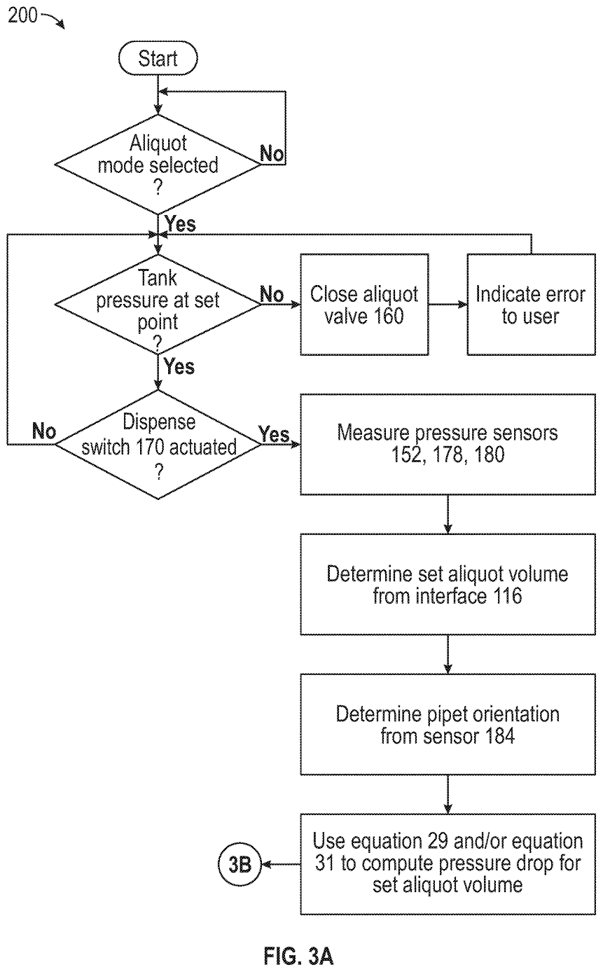

FIGS. 3A and 3B illustrate a flowchart 200 of an exemplary aliquot mode of the pipette controller 100. As shown in flowchart 200, with the aliquot mode of the pipette controller 100 selected, the tank pressure of the pressure tank 128 is determined via the pressure tank sensor 180. If the tank pressure of the pressure tank 128 is not at a set point (i.e., a predetermined tank pressure), the aliquot valve 160 is closed and an error is indicated to the user (e.g., via the volume control interface 116 (FIG. 1)). On the other hand, if the tank pressure of the pressure tank 128 is at the set point and the dispense switch 170 is actuated, the electronic controller 122 reads pressure sensors 152, 178, and 180, which provide the pressures in the pipette conduit 142, the pressure tank 128, and at the dispense air vent 174, respectively. According to some embodiments, atmospheric pressure sensor 178 may be optional, and an atmospheric pressure may be determined by alternate means, such as a manual input. In some embodiments, all pressures measured by are absolute pressures, relative pressure to atmospheric pressure sensors may, however, also be used. Pressure sensors 152, 178, and 180 may also measure the temperature and provide corrections due to changes in temperature as well as pressure.

After the electronic controller 122 reads pressure sensors 152, 178, and 180, the electronic controller 122 determines a set aliquot volume (e.g., as set by the user via the volume control interface 116 (FIG. 1)) and further determines a pipette orientation (e.g., an angle of the pipette 110 relative to a reference axis) via the orientation sensor 184 (FIG. 2). The electronic controller 122 then computes a pressure drop for the set aliquot volume, as described in greater detail below with reference to equation (29) and equation (31) and determines the tank pressure of the pressure tank 128 again via the pressure tank sensor 180. Once the dispense valve 156 is opened (e.g., via actuation of the dispense actuator 114), air that is released from the pressure tank 128 is transmitted to the dispense conduit 148 and through aliquot valve 160 and dispense valve 156 to the pipette conduit 142. Thus, the tank pressure of the pressure tank 128 drops toward the value that corresponds to the set aliquot volume.

The electronic controller 122 closes the aliquot valve 160 once a change in the measured tank pressure (as sensed by pressure tank sensor 180) equals the calculated pressure change from equation (29) or equation (31) described below. If the dispense switch 170 continues to be actuated, the electronic controller 122 can indicate an error to the user (e.g., via the volume control interface 116 (FIG. 1)). With the dispense switch 170 no longer actuated, the electronic controller 122 operates the pump 120 and moves the dispense vent valve 172 to the second position to re-pressurize the pressure tank 128. This process may be repeated for each subsequent aliquot. Other types of pressure vessels may be substituted for pressure tank 128.

Boyle's Law (i.e., PV=nRT) teaches that a container of known volume (V) at a known pressure (P) and temperature (T) will hold a known number of air molecules (n). If the pressure in this volume is reduced a known amount, then a known number of air molecules will be released. According to embodiments, this principle is used to inject a known number of air molecules into a serological pipette (e.g., pipette 110 of FIGS. 1 and 2). The relationship between the quantity of air to be injected into the serological pipette and the set aliquot volume is derived as follows.

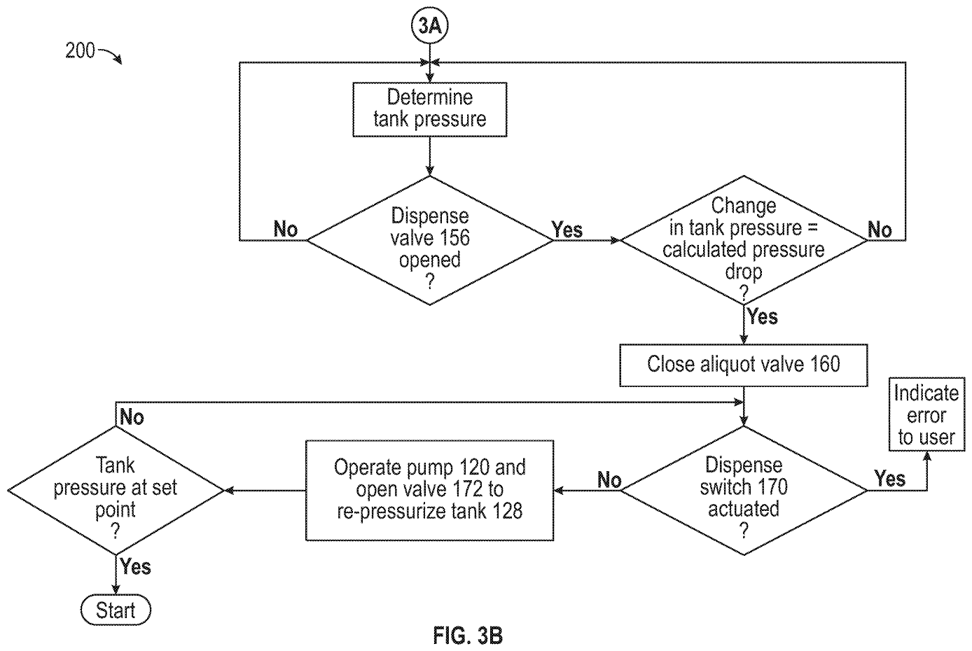

With reference to FIG. 4, Vₚ refers to the total volume of the pipette (e.g., pipette 110). Aₚ refers to the area of the cross-section of the pipette. Pᵢ refers to the initial pressure. Vᵢ refers to the initial volume of fluid within pipette. P_{d} refers to the injected pressure. V_{d} refers to the injected volume. P_{f} refers to final pressure. V_{f} refers to final volume of fluid within pipette 110. The term hᵢ refers to the initial height of the fluid column within pipette 110. The term h_{f} refers to the final height of the fluid column within pipette 110. Pₐₜₘ refers to atmospheric pressure.

Assume T is constant, injecting n number of air molecules is equivalent to injecting a known volume at a known pressure.

P_{d}V_{d}=nRT (1)

Total volume of the pipette remains constant.

Vₚ=Vᵢ+hᵢAₚ=V_{f}+h_{f}Aₚ (2)

Final amount of air in pipette is equal to initial plus injected. Again, assuming that T is constant.

P_{f}V_{f}=PᵢVᵢ+P_{d}V_{d} (3)

Pressure in pipette settles out to be atmospheric minus the weight of the water column.

Pᵢ=Pₐₜₘ−ρghᵢ (4)

P_{f}=Pₐₜₘ−ρgh_{f} (5)

Solve equation (2) for V_{f}.

V_{f}=Vᵢ+hᵢAₚ−h_{f}Aₚ (6)

Substitute P_{f} and Pᵢ from equations (4) and (5) into equation (3).

(Pₐₜₘ−ρgh_{f})V_{f}=(Pₐₜₘ−ρghᵢ)Vᵢ+P_{d}V_{d} (7)

Substitute for Vs from equation (6) into equation (7).

(Pₐₜₘ−ρgh_{f})(Vᵢ+hᵢAₚ−h_{f}Aₚ)=(Pₐₜₘ−ρghᵢ)Vᵢ+P_{d}V_{d} (8)

PₐₜₘVᵢ+PₐₜₘhᵢAₚ−Pₐₜₘh_{f}Aₚ−ρgh_{f}Vᵢ−ρgh_{f}hᵢAₚ+ρgh_{f}²Aₚ=PₐₜₘVᵢ−ρghᵢVᵢ+P_{d}V_{d} (9)

Multiply through, solve for zero, factor out h_{f}.

Pₐₜₘh Aₚ−Pₐₜₘh_{f}Aₚ−ρgh_{f}Vᵢ−ρgh_{f}hᵢAₚ+ρgh_{f}²Aₚ+ρghᵢVᵢ−P_{d}V_{d}=0 (10)

(ρgAₚ)h_{f}²−(PₐₜₘAₚ+μgVᵢ+ρghᵢAₚ)h_{f}+(ρghᵢVᵢ−P_{d}V_{d}+PₐₜₘhᵢAₚ)=0 (11)

Plug in coefficients from equation (11) into quadratic formula to solve for h_{f} (the root where the radical is subtracted is the only one that gives a real answer.

$${h}_{f} = \frac{\begin{matrix}( {P}_{atm} {A}_{p} + ρ {gV}_{i} + ρ {gh}_{i} {A}_{p} ) - \\ \sqrt{\begin{matrix}{( {P}_{atm} {A}_{p} + ρ {gV}_{i} + ρ {gh}_{i} {A}_{p} )}^{2} - 4 ( ρ {gA}_{p} ) \\ ( ρ {gh}_{i} {V}_{i} - {P}_{d} {V}_{d} + {P}_{atm} {h}_{i} {A}_{p} )\end{matrix}}\end{matrix}}{2 ( ρ {gA}_{p} )} \qquad ( 12 )$$

Volume of water dispensed V_{AQ} is equal to change in water column height times pipette cross-sectional area.

V_{AQ}=(hᵢ−h_{f})Aₚ (13)

Define ΔP_{N} as gauge pressure in nozzle (above the surface of the liquid) before the dispense.

ΔP_{N}=Pᵢ−Pₐₜₘ (14)

Solve equations (4) and (5) for hᵢ and h_{f} and substitute in equation (14).

$${h}_{i} = ( \frac{{P}_{atm} - {P}_{i}}{ρ g} ) = \frac{- Δ {P}_{N}}{ρ g} \qquad ( 15 )$$

$${h}_{f} = ( \frac{{P}_{atm} - {P}_{i}}{ρ g} ) - \frac{{V}_{AQ}}{{A}_{P}} = \frac{- Δ {P}_{N}}{ρ g} - \frac{{V}_{AQ}}{{A}_{P}} \qquad ( 16 )$$

Solve equation (10) for P_{d}V_{d}.

P_{d}V_{d}=PₐₜₘhᵢAₚ−Pₐₜₘh_{f}Aₚ−ρgh_{f}Vᵢ−ρgh_{f}hᵢAₚ+ρgh_{f}²Aₚ+ρghᵢVᵢ (17)

Substitute equations (15) and (16) into equation (17).

$${P}_{d} {V}_{d} = {P}_{atm} \frac{- Δ {P}_{N}}{ρ g} {A}_{p} - {P}_{atm} ( \frac{- Δ {P}_{N}}{ρ g} - \frac{{V}_{AQ}}{{A}_{P}} ) {A}_{p} - ρ g ( \frac{- Δ {P}_{N}}{ρ g} - \frac{{V}_{AQ}}{{A}_{P}} ) {V}_{i} - ρ g ( \frac{- Δ {P}_{N}}{ρ g} - \frac{{V}_{AQ}}{{A}_{P}} ) \frac{- Δ {P}_{N}}{ρ g} {A}_{p} + ρ g {( \frac{- Δ {P}_{N}}{ρ g} - \frac{{V}_{AQ}}{{A}_{P}} )}^{2} {A}_{p} + ρ g \frac{- Δ {P}_{N}}{ρ g} {V}_{i} \qquad ( 18 )$$

$${P}_{d} {V}_{d} = {P}_{atm} \frac{Δ {P}_{N}}{ρ g} {A}_{p} - {P}_{atm} \frac{Δ {P}_{N}}{ρ g} {A}_{p} + {P}_{atm} \frac{{V}_{AQ}}{{A}_{P}} {A}_{p} + ρ g \frac{Δ {P}_{N}}{ρ g} {V}_{i} + ρ g \frac{{V}_{AQ}}{{A}_{P}} {V}_{i} - \frac{Δ {P}_{N}}{ρ g} Δ {P}_{N} {A}_{p} - \frac{{V}_{AQ}}{{A}_{P}} Δ {P}_{N} {A}_{p} + ρ g {( \frac{- Δ {P}_{N}}{ρ g} )}^{2} {A}_{p} + 2 ρ g \frac{Δ {P}_{N}}{ρ g} \frac{{V}_{AQ}}{{A}_{P}} {A}_{p} + ρ g {( \frac{{V}_{AQ}}{{A}_{P}} )}^{2} {A}_{p} - Δ {P}_{N} {V}_{i} \qquad ( 19 )$$

$${P}_{d} {V}_{d} = {P}_{atm} {V}_{AQ} + Δ {P}_{N} {V}_{i} + ρ g \frac{{V}_{AQ}}{{A}_{P}} {V}_{i} - \frac{Δ {P}_{N}^{2}}{ρ g} {A}_{p} - {V}_{AQ} Δ {P}_{N} + \frac{Δ {P}_{N}^{2}}{ρ g} {A}_{p} + 2 Δ {P}_{N} {V}_{AQ} + ρ g \frac{{V}_{AQ}^{2}}{{A}_{P}} - Δ {P}_{N} {V}_{i} \qquad ( 20 )$$

Multiply through, and simplify a few times.

$${P}_{d} {V}_{d} = {P}_{atm} {V}_{AQ} + ρ g \frac{{V}_{AQ}}{{A}_{P}} {V}_{i} + Δ {P}_{N} {V}_{AQ} + ρ g \frac{{V}_{AQ}^{2}}{{A}_{P}} \qquad ( 21 )$$

Solve equation (2) for Vᵢ and substitute in equation (15).

$${V}_{i} = {V}_{p} - {h}_{i} {A}_{p} = {V}_{p} + \frac{Δ {P}_{N}}{ρ g} {A}_{p} \qquad ( 22 )$$

Substitute equation (22) into equation (21).

$${P}_{d} {V}_{d} = {P}_{atm} {V}_{AQ} + ρ g \frac{{V}_{AQ}}{{A}_{P}} ( {V}_{p} + \frac{Δ {P}_{N}}{ρ g} {A}_{p} ) + Δ {P}_{N} {V}_{AQ} + ρ g \frac{{V}_{AQ}^{2}}{{A}_{P}} \qquad ( 23 )$$

Multiply through and simplify.

$${P}_{d} {V}_{d} = {P}_{atm} {V}_{AQ} + ρ g \frac{{V}_{AQ}}{{A}_{P}} {V}_{p} + ρ g \frac{{V}_{AQ}}{{A}_{P}} \frac{Δ {P}_{N}}{ρ g} {A}_{p} + Δ {P}_{N} {V}_{AQ} + ρ g \frac{{V}_{AQ}^{2}}{{A}_{P}} \qquad ( 24 )$$

$${P}_{d} {V}_{d} = {P}_{atm} {V}_{AQ} + ρ g \frac{{V}_{AQ}}{{A}_{P}} {V}_{p} + 2 Δ {P}_{N} {V}_{AQ} + ρ g \frac{{V}_{AQ}^{2}}{{A}_{P}} \qquad ( 25 )$$

Factor out desired dispense volume.

$${P}_{d} {V}_{d} = {V}_{AQ} ( {P}_{atm} + ρ g \frac{{V}_{p}}{{A}_{P}} + 2 Δ {P}_{N} + ρ g \frac{{V}_{AQ}}{{A}_{P}} ) \qquad ( 26 )$$

Simplify.

$${P}_{d} {V}_{d} = {V}_{AQ} ( {P}_{atm} + 2 Δ {P}_{N} + ρ g \frac{( {V}_{p} + {V}_{AQ} )}{{A}_{P}} ) \qquad ( 27 )$$

Solve equation (26) for Pa.

$${P}_{d} = \frac{{V}_{AQ}}{{V}_{d}} ( {P}_{atm} + 2 Δ {P}_{N} + ρ g \frac{( {V}_{p} + {V}_{AQ} )}{{A}_{P}} ) \qquad ( 28 )$$

When V_{d} is taken to be the volume of the pressure tank, P_{d} would be the required drop in the pressure tank pressure to dispense V_{AQ} of liquid given assumptions about the cross-sectional area (Aₚ) and the volume (Vₚ) of the pipettes and going off of the nozzle gauge pressure (ΔP_{N}), also assuming water density, and generally isothermal conditions, and an entirely cylindrical pipette. (Vₚ should include the dead volume inside the controller air path, so replace Vₚ with Vₚ+V_{dv}.)

$${P}_{d} = \frac{{V}_{AQ}}{{V}_{d}} ( {P}_{atm} + 2 Δ {P}_{N} + ρ g \frac{( {V}_{p} + {V}_{dv} + {V}_{AQ} )}{{A}_{P}} ) \qquad ( 29 )$$

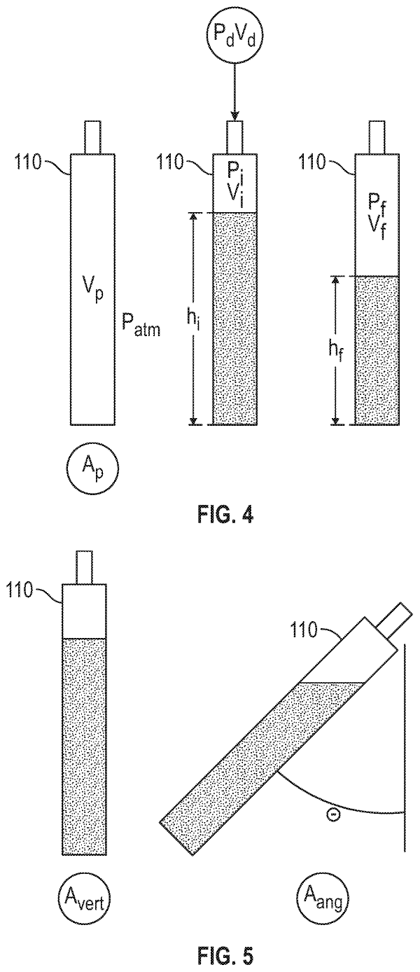

Referring to FIG. 5, according to embodiments, an orientation of a pipette may be determined. For example, the orientation of pipette 110 may be determined by the electronic controller 122 using the orientation sensor 184 (FIG. 2). In the event that the pipette is held at an angle θ instead of vertically, the volume terms in equation (29) will remain the same since volume is independent of orientation. The Aₚ term is, however, affected, since the area of the water in the pipette that the air pressure now has an effect on is a larger oval rather than the original circle that is present when the pipette is held vertically.

$${A}_{ang} = \frac{{A}_{vert}}{cos ( θ )} \qquad ( 30 )$$

One way to solve for the change in the Aₚ term is to take advantage of the fact that the volume of water is independent of Θ.

V_{w}=Aᵥₑᵣₜh_{WCvert}=A_{ang}h_{WCang}=A_{ang}(h_{WCvert} cos(Θ)) (31)

The product of the area of the pipette when the pipette is vertical and the height of the water column when the pipette is vertical (h_{WCvert}) is equal to the product of the area of the pipette when the pipette is angled and the height of the water column when the pipette is angled (h_{WCang}). Given the geometry of the arrangement, the height of the water column when it is angled is cos(Θ) times the height of the vertical water column, so solving for the area of the angled pipette results in equation (30).

Substituting this definition of the area of the pipette that accounts for the angle back into equation (29) provides:

$${P}_{d} = \frac{{V}_{AQ}}{{V}_{d}} ( {P}_{atm} + 2 Δ {P}_{N} + ρ g \frac{( {V}_{p} + {V}_{dv} + {V}_{AQ} )}{\frac{{A}_{P}}{cos ( θ )}} ) \qquad ( 32 )$$

Based on the derivation above, the electronic controller 122 uses this equation to compute the pressure drop P_{d} required to achieve the set aliquot volume V_{AQ}. Note that the dead volume V_{dv} in the pipette controller is small relative to the serological pipette volume Vₚ, and that the set aliquot volume V_{AQ} is also usually small relative to Vₚ. Therefore, the term (Vₚ+V_{dv}+V_{AQ})/Aₚ is approximately equal to Vₚ/Aₚ. This is the length of the serological pipette, and since most serological pipettes are about the same length, this term is relatively constant and can be ignored to a first order effect. Alternatively, −Vₚ, V_{dv} and Aₚ could be entered via a keypad or other data entry method.

In addition to the manual aspiration mode described above, the pipette controller 100 can be configured to also be operated, via the electronic controller 122, in the measured aspiration mode. With the measured aspiration mode of the pipette controller 100 selected, a precise volume of fluid can be aspirated into the pipette 110 in response to engagement of the aspiration actuator 112. To initiate the measured aspiration mode, a user may select the measured aspiration mode from the manual aspiration mode, the dispense mode, or the aliquot mode (e.g., via the volume control interface 116). Further, in the measured aspiration mode, the user may also select the aspiration volume (i.e., a set aspiration volume) via the volume control interface 116. In response to an initial engagement of the aspiration actuator 112, the set aspiration volume is aspirated into the pipette 110.

In some embodiments, the pipette controller 100 can be configured to aspirate the set aspiration volume again into the pipette 110 with each subsequent engagement of the aspiration actuator 112. For example, one (1) ml of fluid may first be aspirated into the pipette 110 in response to an initial engagement of the aspiration actuator 112 and then, in response to a second engagement of the aspiration actuator 112, an additional one (1) ml of fluid may be aspirated into the pipette 110.

While operating in the measured aspiration mode, the electronic controller 122 can be configured to achieve a predetermined tank air pressure within the pressure tank corresponding to the set aspiration volume. For example, as air is pumped into the pressure tank 128 along the aspiration conduit 140, the electronic controller 122 can be configured to determine when the predetermined tank air pressure is reached (e.g., via pressure tank sensor 180) and, in response, can close the aspiration control valve 161. In some embodiments, the electronic controller 122 can be further configured to determine a predetermined target tank air pressure that can provide for two or more set aspiration volumes.

In addition to the manual aspiration mode and the measured aspiration mode described above, the pipette controller 100 can be configured to also be operated, via the electronic controller 122, in the dilution mode. With the dilution mode of the pipette controller 100 selected, at least two precise set aspiration volumes can be aspirated into the pipette 110 in sequence. For example, a first volume of fluid can be aspirated into the pipette 110 in response to a first engagement of the aspiration actuator 112 and a second volume of fluid, that can be different than the first volume of fluid, can be aspirated into the pipette 110 in response to a second engagement of the aspiration actuator 112. In some embodiments, the first volume of fluid can be a first fluid (e.g., a sample fluid) and the second volume of fluid can be a second fluid that is different than the first fluid (e.g., a diluent fluid).

To initiate the dilution mode of the pipette controller 100, a user may select the dilution mode from the manual aspiration mode, the measured aspiration mode, the dispense mode, or the aliquot mode (e.g., via the volume control interface 116). Further, in the dilution mode, the user may also select the set aspiration volumes (e.g., a first set aspiration volume and a second set aspiration volume) via the volume control interface 116. In response to an initial engagement of the aspiration actuator 112, the first set aspiration volume is aspirated into the pipette 110, and, in response to subsequent engagement of the aspiration actuator 112, the second set aspiration volume (e.g., that is different than the first set aspiration volume) is aspirated into the pipette 110. For example, the first set aspiration volume can be of a sample fluid and the second set aspiration volume can be of a diluent fluid. From the dilution mode, and with the desired volume of fluid (or mixture of fluids) aspirated into the pipette 110, the volume of fluid can be dispensed from the pipette 110 via operation of the pipette controller 100 in one of the dispense mode or the aliquot mode. For example, after a sample fluid and a diluent fluid are aspirated into the pipette 110 via the dilution mode, the sample fluid and the diluent fluid may be subsequently mixed and dispensed together from the pipette 110 via the dispense mode or the aliquot mode.

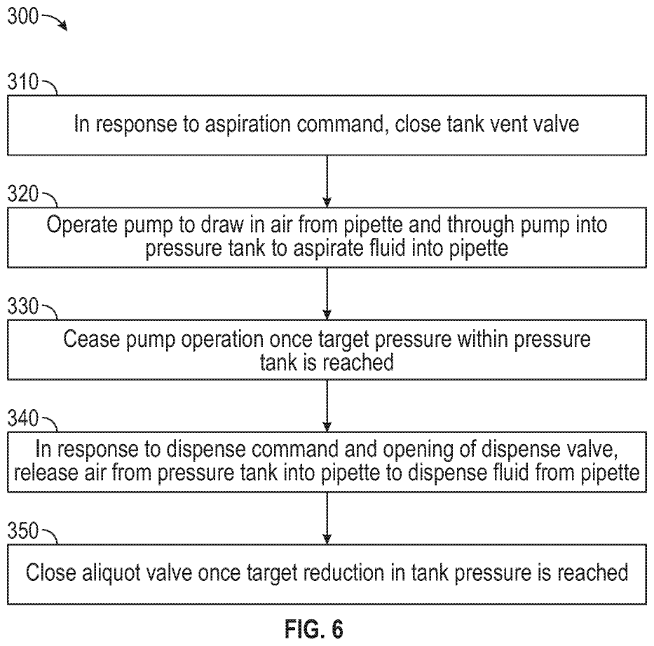

FIG. 6 is a flowchart showing a method 300 of aspirating and dispensing a fluid from a pipette using a pipette controller. While reference is made to the pipette controller 100 of FIGS. 1 and 2, the method 300 can be utilized with any type of apparatus that aspirates and dispenses a fluid.

As shown in FIG. 6, the method 300 includes, in step 310, in response to an aspiration command, closing a tank vent valve, and, in step 320, operating a pump to draw in air from a pipette and through the pump into a pressure tank to aspirate fluid into the pipette. For example, with reference to the pipette controller 100 illustrated in FIGS. 1 and 2, step 310 can include, in response to the electronic controller 122 receiving an aspiration command from the aspiration valve 154 (i.e., via the aspiration switch 164), the electronic controller 122 can move the tank vent valve 173 from the first position (i.e., a normally closed position) to the second position, and step 320 can include operating the pump 120 to draw in air from the nozzle assembly 108 and into the pressure tank 128 along the aspiration conduit 140 and the pump conduit 138. In some embodiments, step 310 and step 320 can be performed simultaneously. In some embodiments, step 320 can be performed before step 310.

The method 300 further includes, in step 330, ceasing operation of the pump once a target tank pressure within the pressure tank is reached. For example, with reference again to the pipette controller 100 illustrated in FIGS. 1 and 2, step 330 can include ceasing operation of the pump 120, via the electronic controller 122, once a target tank pressure within the pressure tank 128 is reached (e.g., as determined by the electronic controller 122 in electrical communication with the pressure tank sensor 180).

The method 300 further includes, in step 340, in response to a dispense command and opening of a dispense valve, release air from pressure tank into pipette to dispense fluid from the pipette, and, in step 350, closing the aliquot valve once a target reduction in tank pressure of the pressure tank is reached. For example, with reference again to the pipette controller 100 illustrated in FIGS. 1 and 2, step 340 can include, in response to the electronic controller 122 receiving the dispense command (e.g., via the dispense switch 170) and the dispense vent valve 172 being moved from the first position (i.e., the normally closed position) to the second position, accumulated air within the pressure tank 128 is released from the pressure tank 128 into the pipette 110 to dispense fluid from the pipette 110. Further, step 350 can include closing, via the electronic controller 122, the aliquot valve 160 once a target tank pressure within the pressure tank 128 is reached (e.g., as determined by the electronic controller 122 in electrical communication with the pressure tank sensor 180).

In some embodiments, the dispense command, as received in step 340, can be provided when a user engages a dispense actuator of the pipette controller that is operable by the user to move a dispense valve from a closed position toward an open position. In some embodiments, a dispense speed of an aliquot volume, as dispensed in step 340, can be varied by a user via a dispense actuator. In some embodiments, an aliquot volume of fluid to be dispensed from the pipette, as in step 340, can be selectable via a volume control interface of the pipette controller.

In some embodiments, method 300 can further include, in response to a measured dispense command, dispensing a set aliquot volume of the fluid from the pipette when the dispense valve is moved from the closed position toward the open position. In some such embodiments, method 300 can further include determining, via a tank pressure sensor, when the tank air pressure reaches a predetermined tank air pressure corresponding to an amount of air transferred from the pressure tank to the pipette to dispense the set aliquot volume. In some such embodiments, method 300 can further include, when the tank air pressure reaches the predetermined tank air pressure, moving an aliquot valve from a normally open position to a closed position. In some such embodiments, method 300 can further include reinjecting air, via the pump, into the pressure tank to a predetermined target tank air pressure corresponding to the set aliquot volume.

In some embodiments, method 300 can further include determining, via a tank pressure sensor, when the tank air pressure reaches a predetermined tank air pressure corresponding to the aspirate volume. In some embodiments, the aspiration command can be provided when a user engages an aspiration actuator of the pipette controller, the aspiration actuator being operable by the user to move an aspiration valve from a closed position toward an open position. In some such embodiments, an aspiration speed of the aspirate volume can be varied by a user via the aspiration actuator.

Accordingly, the present disclosure provides for a pipette controller that can provide for accurate dispensing of aliquots of liquid via a single dispense actuator. Thus, embodiments of the present disclosure can provide a pipette controller that accurately dispenses aliquots of liquid, but with a significantly less complex system structure, thus, providing a reduced overall size and weight, as compared to conventional pipette controllers.

Further aspects of the present disclosure are provided by the subject matter of the following clauses.

A pipette controller includes a pipette holder configured to operatively connect a pipette to the pipette controller, a pressure tank pneumatically connected to the pipette holder, a pump pneumatically connected to the pipette holder and to the pressure tank, a dispense valve, an aspiration valve, and an electronic controller in electrical communication with the pump, the dispense valve, and the aspiration valve. The electronic controller is configured, in response to receiving an aspiration command signal from the aspiration valve, to operate the pump to draw in air from the pipette holder and into the pressure tank, and, in response to receiving a dispense command signal from the dispense valve, to release accumulated air from within the pressure tank to flow into the pipette holder.

The pipette controller of the preceding clause, further including a dispense actuator operable by a user to move the dispense valve from a closed position toward an open position and an aspiration actuator operable by the user to move the aspiration valve from a closed position toward an open position.

The pipette controller of any preceding clause, further including a dispense switch and an aspiration switch in electrical communication with the electronic controller, the dispense switch being arranged to detect actuation of the dispense actuator and to provide the dispense command signal to the electronic controller, the aspiration switch being arranged to detect actuation of the aspiration actuator and to provide the aspiration command signal to the electronic controller.

The pipette controller of any preceding clause, the electronic controller being further configured, in response to receiving the aspiration command signal, to selectively connect the pressure tank to atmosphere, and, in response to receiving the dispense command signal, to selectively connect a pump inlet of the pump to atmosphere.

The pipette controller of any preceding clause, further including an aspiration air vent in pneumatic connection with atmosphere, a tank vent valve movable between a first position, in which airflow is prevented between the pressure tank and the aspiration air vent, and a second position, in which airflow is permitted between the pressure tank and the aspiration air vent, a dispense air vent in pneumatic connection with the atmosphere, and a dispense vent valve movable between a first position, in which airflow is prevented between a pump inlet of the pump and the dispense air vent, and a second position, in which airflow is permitted between the pump inlet and the dispense air vent. The tank vent valve and the dispense vent valve are in electrical communication with the electronic controller, and the electronic controller is further configured, in response to receiving the aspiration command signal, to move the tank vent valve to the second position, and, in response to receiving the dispense command signal, to move the dispense vent valve to the second position.

The pipette controller of any preceding clause, the electronic controller being further configured, in response to receiving the aspiration command signal, to selectively connect the pressure tank to atmosphere.

The pipette controller of any preceding clause, further including an aspiration air vent in pneumatic connection with atmosphere and a tank vent valve movable between a first position, in which airflow is prevented between the pressure tank and the aspiration air vent, and a second position, in which airflow is permitted between pressure tank and the aspiration air vent. The tank vent valve is in electrical communication with the electronic controller, and the electronic controller is further configured, in response to receiving the aspiration command signal, to move the tank vent valve to the second position.

The pipette controller of any preceding clause, the electronic controller being further configured, in response to receiving the dispense command signal, to selectively connect a pump inlet of the pump to atmosphere.

The pipette controller of any preceding clause, further including a dispense air vent in pneumatic connection with atmosphere and a dispense vent valve movable between a first position, in which airflow is prevented between a pump inlet of the pump and the dispense air vent, and a second position, in which airflow is permitted between the pump inlet and the dispense air vent. The dispense vent valve is in electrical communication with the electronic controller, and the electronic controller is further configured, in response to receiving the dispense command signal, to move the dispense vent valve to the second position.

The pipette controller of any preceding clause, further including an aliquot valve in electrical communication with the electronic controller. The electronic controller is further configured, in response to receiving the dispense command signal, to move the aliquot valve from an open position, in which flow is permitted between the pressure tank and the dispense valve, to a closed position, in which flow is prevented between the pressure tank and the dispense valve.

The pipette controller of any preceding clause, the electronic controller being further configured, in response to receiving the dispense command signal, to release the aliquot valve from the closed position to the open position such that, when the dispense valve is moved toward the open position, air from the pressure tank flows through the aliquot valve and the dispense valve to the pipette holder.

The pipette controller of any preceding clause, the aliquot valve being a normally open solenoid actuated ball valve.

The pipette controller of any preceding clause, when the dispense valve is moved toward the open position, the air from the pressure tank flows through the aliquot valve and then through the dispense valve to the pipette holder.

The pipette controller of any preceding clause, the pressure tank being pneumatically connected to a pipette conduit of the pipette holder via a dispense conduit extending from the pressure tank to the pipette conduit, the aliquot valve and the dispense valve being arranged along the dispense conduit. The pump is pneumatically connected to the pipette holder via an aspiration conduit extending from a pump inlet to the pipette conduit and to the pressure tank via a pump conduit extending from a pump outlet to the pipette holder, the aspiration valve being arranged along the aspiration conduit.

The pipette controller of any preceding clause, the dispense valve being arranged along the dispense conduit between the aliquot valve and the pipette conduit.

The pipette controller of any preceding clause, further including a pressure tank sensor in electrical communication with the electronic controller and arranged to sense a tank air pressure within the pressure tank.

The pipette controller of any preceding clause, the electronic controller being further configured to determine, based on signals received from the pressure tank sensor, when the tank air pressure reaches a predetermined tank air pressure corresponding to an aliquot volume.

The pipette controller of any preceding clause, further including a volume control interface in electrical communication with the electronic controller, the volume control interface being operable to set the aliquot volume.

The pipette controller of any preceding clause, the electronic controller being further configured to determine, based on signals received from the pressure tank sensor, when the tank air pressure reaches a predetermined tank air pressure corresponding to an amount of air transferred from the pressure tank to the pipette holder to dispense a volume of fluid equal to an aliquot volume.

The pipette controller of any preceding clause, the electronic controller being further configured, when the tank air pressure reaches the predetermined tank air pressure, to operate the pump to reinject air into the pressure tank to a predetermined target tank air pressure.

The pipette controller of any preceding clause, further including a volume control interface in electrical communication with the electronic controller, the volume control interface being operable to set the aliquot volume.

A pipette controller includes a pipette holder configured to operatively connect a pipette to the pipette controller, a pressure tank pneumatically connected to a pipette conduit of the pipette holder via a dispense conduit extending from the pressure tank to the pipette conduit, a pump pneumatically connected to the pipette holder via an aspiration conduit extending from a pump inlet to the pipette conduit and to the pressure tank via a pump conduit extending from a pump outlet to the pressure tank, the pump being configured to inject air into the pressure tank along the pump conduit to create positive air pressure inside the pressure tank, a dispense valve arranged along the dispense conduit, a dispense actuator operable by a user to move the dispense valve from a closed position toward a fully open position, an aspiration valve arranged along the aspiration conduit, an aspiration actuator operable by the user to move the aspiration valve from a closed position toward an open position, and an electronic controller in electrical communication with the dispense valve and the aspiration actuator. The electronic controller is configured, in response to an aspiration command signal being received from the aspiration actuator, to operate the pump to draw in air from the pipette holder along the aspiration conduit and into the pressure tank, and, in response to a dispense command signal being received from the dispense actuator, to operate the pump to inject air into the pressure tank.

The pipette controller of the preceding clause, the dispense actuator being configured such that the dispense valve is movable, via the dispense actuator, to one of a plurality of partially open positions between the closed position and the fully open position to vary flow of the positive air pressure through the dispense valve.

The pipette controller of any preceding clause, the dispense actuator including a dispense interface operatively connected to the dispense actuator and a dispense switch in electrical communication with the electronic controller. The dispense switch being arranged to detect a dispense trigger event initiated by the user via the dispense interface and being configured, in response to detecting the dispense trigger event, to provide the dispense command signal to the electronic controller.

The pipette controller of any preceding clause, further including an aspiration air vent in pneumatic connection with atmosphere, a tank vent valve movable between a first position, in which airflow is prevented between the pressure tank and the aspiration air vent, and a second position, in which airflow is permitted between pressure tank and the aspiration air vent, a dispense air vent in pneumatic connection with the atmosphere, and a dispense vent valve movable between a first position, in which airflow is prevented between a pump inlet of the pump and the dispense air vent, and a second position, in which airflow is permitted between the pump inlet and the dispense air vent. The tank vent valve and the dispense vent valve are in electrical communication with the electronic controller, and the electronic controller is further configured, in response to receiving the aspiration command signal, to move the tank vent valve to the second position, and, in response to receiving the dispense command signal, to move the dispense vent valve to the second position.

The pipette controller of any preceding clause, further including an aspiration air vent in pneumatic connection with atmosphere and a tank vent valve movable between a first position, in which airflow is prevented between the pressure tank and the aspiration air vent, and a second position, in which airflow is permitted between pressure tank and the aspiration air vent. The tank vent valve is in electrical communication with the electronic controller, and the electronic controller is further configured, in response to receiving the aspiration command signal, to move the tank vent valve to the second position.

The pipette controller of any preceding clause, further including a dispense air vent in pneumatic connection with atmosphere and a dispense vent valve movable between a first position, in which airflow is prevented between a pump inlet of the pump and the dispense air vent, and a second position, in which airflow is permitted between the pump inlet and the dispense air vent. The dispense vent valve is in electrical communication with the electronic controller, and the electronic controller is further configured, in response to receiving the dispense command signal, to move the dispense vent valve to the second position.

The pipette controller of any preceding clause, further including an aliquot valve arranged along the dispense conduit.

The pipette controller of any preceding clause, the dispense valve being arranged along the dispense conduit between the aliquot valve and the pipette conduit.

The pipette controller of any preceding clause, the aliquot valve being a normally open solenoid actuated ball valve.

The pipette controller of any preceding clause, further including an aspiration control valve arranged along the aspiration conduit.

The pipette controller of any preceding clause, the aspiration valve being arranged along the aspiration conduit between the aspiration control valve and the pipette conduit.

The pipette controller of any preceding clause, the aspiration control valve being a normally open solenoid actuated ball valve.

The pipette controller of any preceding clause, further including a pressure tank sensor arranged to sense a tank air pressure within the pressure tank. The electronic controller being further configured to determine, based on signals received from the pressure tank sensor, when the tank air pressure reaches a predetermined tank air pressure corresponding to an amount of air transferred from the pressure tank to the pipette holder to dispense a volume of fluid equal to an aliquot volume.

The pipette controller of any preceding clause, further including a volume control interface in electrical communication with the electronic controller, the volume control interface being operable by the user to set the aliquot volume.

The pipette controller of any preceding clause, further including an orientation sensor in electrical communication with the electronic controller and configured, when the pipette is coupled to the pipette holder, to sense an angle of the pipette relative to a reference axis. The electronic controller being further configured to determine, based on signals received from the orientation sensor, the angle of the pipette and to adjust, based on the determined angle of the pipette, the amount of air transferred from the pressure tank to the pipette holder to dispense the volume of fluid equal to the aliquot volume.

The pipette controller of any preceding clause, the dispense actuator being configured such that the dispense valve is movable, via the dispense actuator, to one of a plurality of partially open positions between the closed position and the fully open position to vary a dispense speed of the aliquot volume.

A method of aspirating and dispensing a fluid from a pipette using a pipette controller, the method including, in response to an aspiration command, closing a tank vent valve of the pipette controller, operating a pump of the pipette controller to draw in air from the pipette and through the pump into a pressure tank of the pipette controller to aspirate an aspirate volume of fluid into the pipette, ceasing operation of the pump once a target tank pressure within the pressure tank is reached, in response to a dispense command and opening of a dispense valve of the pipette controller, releasing air from the pressure tank into the pipette to dispense an aliquot volume of fluid from the pipette, and closing an aliquot valve of the pipette controller once a target reduction in the tank pressure within the pressure tank is reached.

The method of the preceding clause, further including, in response to the aspiration command, selectively connecting the pressure tank to atmosphere and, in response to the dispense command, selectively connecting a pump inlet of the pump to the atmosphere.

The method of any preceding clause, the pressure tank being selectively connected to the atmosphere by opening the tank vent valve in pneumatic connection to the pressure tank and an aspiration air vent, and the pump inlet being selectively connected to atmosphere by opening a dispense vent valve in pneumatic connection to the pump inlet and a dispense air vent.

The method of any preceding clause, the dispense command being provided when a user engages a dispense actuator of the pipette controller, the dispense actuator being operable by the user to move a dispense valve from a closed position toward an open position.

The method of any preceding clause, the dispense speed of the aliquot volume can be varied by a user via the dispense actuator.

The method of any preceding clause, the aliquot volume of fluid to be dispensed from the pipette being selectable via a volume control interface of the pipette controller.

The method of any preceding clause, further including determining, via a tank pressure sensor, when the tank air pressure reaches a predetermined tank air pressure corresponding to an amount of air transferred from the pressure tank to the pipette to dispense the aliquot volume.

The method of any preceding clause, further including, when the tank air pressure reaches the predetermined tank air pressure, moving the aliquot valve from a normally open position to a closed position.

The method of any preceding clause, further including reinjecting air, via the pump, into the pressure tank to a predetermined target tank air pressure corresponding to the aliquot volume.

The method of any preceding clause, the aspirate volume of fluid to be aspirated into the pipette being selectable via a volume control interface of the pipette controller.

The method of any preceding clause, further including determining, via a tank pressure sensor, when the tank air pressure reaches a predetermined tank air pressure corresponding to the aspirate volume.

The method of any preceding clause, the aspiration command being provided when a user engages an aspiration actuator of the pipette controller, the aspiration actuator being operable by the user to move an aspiration valve from a closed position toward an open position.

The method of any preceding clause, an aspiration speed of the aspirate volume can be varied by a user via the aspiration actuator.

Although the foregoing description is directed to some embodiments of the present disclosure, other variations and modifications will be apparent to those skilled in the art and may be made without departing from spirit and scope of the present disclosure. Moreover, features described in connection with one embodiment of the present disclosure may be used in conjunction with other embodiments, even if not explicitly stated above.

1. A pipette controller comprising:
a pipette holder configured to operatively connect a pipette to the pipette controller;
a pressure tank pneumatically connected to the pipette holder;
a pump pneumatically connected to the pipette holder and to the pressure tank;
a dispense valve;
an aspiration valve; and
an electronic controller in electrical communication with the pump, the dispense valve, and the aspiration valve, the electronic controller being configured:
in response to receiving an aspiration command signal from the aspiration valve, to operate the pump to draw in air from the pipette holder and into the pressure tank; and
in response to receiving a dispense command signal from the dispense valve, to release accumulated air from within the pressure tank to flow into the pipette holder.

2. The pipette controller of claim 1, further comprising:
a dispense actuator operable by a user to move the dispense valve from a closed position toward an open position; and
an aspiration actuator operable by the user to move the aspiration valve from a closed position toward an open position.

3. The pipette controller of claim 2, further comprising:
a dispense switch in electrical communication with the electronic controller, the dispense switch being arranged to detect actuation of the dispense actuator and to provide the dispense command signal to the electronic controller; and
an aspiration switch in electrical communication with the electronic controller, the aspiration switch being arranged to detect actuation of the aspiration actuator and to provide the aspiration command signal to the electronic controller.

4. The pipette controller of claim 1, wherein the electronic controller is further configured:
in response to receiving the aspiration command signal, to selectively connect the pressure tank to atmosphere; and
in response to receiving the dispense command signal, to selectively connect a pump inlet of the pump to atmosphere.

5. The pipette controller of claim 4, further comprising:
an aspiration air vent in pneumatic connection with atmosphere;
a tank vent valve movable between a first position, in which airflow is prevented between the pressure tank and the aspiration air vent, and a second position, in which airflow is permitted between the pressure tank and the aspiration air vent;
a dispense air vent in pneumatic connection with the atmosphere; and
a dispense vent valve movable between a first position, in which airflow is prevented between a pump inlet of the pump and the dispense air vent, and a second position, in which airflow is permitted between the pump inlet and the dispense air vent,
wherein the tank vent valve and the dispense vent valve are in electrical communication with the electronic controller, and the electronic controller is further configured:
in response to receiving the aspiration command signal, to move the tank vent valve to the second position; and
in response to receiving the dispense command signal, to move the dispense vent valve to the second position.

6. The pipette controller of claim 1, wherein the electronic controller is further configured, in response to receiving the aspiration command signal, to selectively connect the pressure tank to atmosphere.

7. The pipette controller of claim 6, further comprising:
an aspiration air vent in pneumatic connection with atmosphere; and
a tank vent valve movable between a first position, in which airflow is prevented between the pressure tank and the aspiration air vent, and a second position, in which airflow is permitted between pressure tank and the aspiration air vent,
wherein the tank vent valve is in electrical communication with the electronic controller, and the electronic controller is further configured, in response to receiving the aspiration command signal, to move the tank vent valve to the second position.

8. The pipette controller of claim 6, wherein the electronic controller is further configured, in response to receiving the dispense command signal, to selectively connect a pump inlet of the pump to atmosphere.

9. The pipette controller of claim 8, further comprising:
a dispense air vent in pneumatic connection with atmosphere; and
a dispense vent valve movable between a first position, in which airflow is prevented between a pump inlet of the pump and the dispense air vent, and a second position, in which airflow is permitted between the pump inlet and the dispense air vent,
wherein the dispense vent valve is in electrical communication with the electronic controller, and the electronic controller is further configured, in response to receiving the dispense command signal, to move the dispense vent valve to the second position.

10. The pipette controller of claim 1, further comprising an aliquot valve in electrical communication with the electronic controller,
wherein the electronic controller is further configured, in response to receiving the dispense command signal, to move the aliquot valve from an open position, in which flow is permitted between the pressure tank and the dispense valve, to a closed position, in which flow is prevented between the pressure tank and the dispense valve.

11. The pipette controller of claim 10, wherein the electronic controller is further configured, in response to receiving the dispense command signal, to release the aliquot valve from the closed position to the open position such that, when the dispense valve is moved toward the open position, air from the pressure tank flows through the aliquot valve and the dispense valve to the pipette holder.

12. The pipette controller of claim 10, wherein, when the dispense valve is moved toward the open position, the air from the pressure tank flows through the aliquot valve and then through the dispense valve to the pipette holder.

13. The pipette controller of claim 10, wherein the pressure tank is pneumatically connected to a pipette conduit of the pipette holder via a dispense conduit extending from the pressure tank to the pipette conduit, the aliquot valve and the dispense valve being arranged along the dispense conduit, and
wherein the pump is pneumatically connected to the pipette holder via an aspiration conduit extending from a pump inlet to the pipette conduit and to the pressure tank via a pump conduit extending from a pump outlet to the pipette holder, the aspiration valve being arranged along the aspiration conduit.

14. The pipette controller of claim 13, wherein the dispense valve is arranged along the dispense conduit between the aliquot valve and the pipette conduit.

15. The pipette controller of claim 1, further comprising a pressure tank sensor in electrical communication with the electronic controller and arranged to sense a tank air pressure within the pressure tank.

16. The pipette controller of claim 15, wherein the electronic controller is further configured:
to determine, based on signals received from the pressure tank sensor, when the tank air pressure reaches a predetermined tank air pressure corresponding to an amount of air transferred from the pressure tank to the pipette holder to dispense a volume of fluid equal to an aliquot volume; and
when the tank air pressure reaches the predetermined tank air pressure, to operate the pump to reinject air into the pressure tank to a predetermined target tank air pressure.

17. The pipette controller of claim 16, further comprising a volume control interface in electrical communication with the electronic controller, the volume control interface being operable to set the aliquot volume.

18. A method of aspirating and dispensing a fluid from a pipette using a pipette controller, the method comprising:
in response to an aspiration command, closing a tank vent valve of the pipette controller;
operating a pump of the pipette controller to draw in air from the pipette and through the pump into a pressure tank of the pipette controller to aspirate an aspirate volume of fluid into the pipette;
ceasing operation of the pump once a target tank pressure within the pressure tank is reached;
in response to a dispense command and opening of a dispense valve of the pipette controller, releasing air from the pressure tank into the pipette to dispense an aliquot volume of fluid from the pipette; and
closing an aliquot valve of the pipette controller once a target reduction in the tank pressure within the pressure tank is reached.

19. The method of claim 18, further comprising:
in response to the aspiration command, selectively connecting the pressure tank to atmosphere; and
in response to the dispense command, selectively connecting a pump inlet of the pump to the atmosphere.

20. The method of claim 18, further comprising:
determining, via a tank pressure sensor, when the tank air pressure reaches a predetermined tank air pressure corresponding to an amount of air transferred from the pressure tank to the pipette to dispense the aliquot volume; and
when the tank air pressure reaches the predetermined tank air pressure, moving the aliquot valve from a normally open position to a closed position.
